(19) United States
(12) Patent Application Publication
(10) Pub. No.: US 2010/0153948 A1
(43) Pub. Date: Jun. 17, 2010

(54) COMBINED WEB AND LOCAL COMPUTING ENVIRONMENT

(75) Inventors: Zvi SCHREIBER, Jerusalem (IL); Gilad PARANN-NISSANY, Ramat Hasharon (IL)

Correspondence Address: SIMON KAHN - PYI Tech, Ltd.;c/o LANDONIP, INC, 1725 Jamieson Avenue, ALEXANDRIA, VA, 22314, US

(73) Assignee: GHOST, INC., Tortola (VG)

(21) Appl. No.: 12/635,223

(22) Filed: Dec. 10, 2009

Related U.S. Application Data
(60) Provisional application No. 61/121,546, filed on Dec. 11, 2008.

(51) Int. Cl. G06F 9/455; G06F 3/048; G06F 3/033

(52) U.S. Cl. 718/1; 715/760; 715/863

(57) ABSTRACT

A system and method enabling two way communication between a virtual hosted operating system running in a web page and the local operating system and applications in order to allow a user to combine the advantages of both systems.

### CROSS-REFERENCE TO RELATED APPLICATIONS

This application claims priority from U.S. Provisional Patent Application Ser. No. 61/121,546 filed Dec. 11, 2008, entitled “Combined Web and Local Computing Environment”, the entire contents of which are incorporated herein by reference.

### BACKGROUND OF THE INVENTION

Historically, personal computing was carried out using applications installed on an operating system installed locally on a physical computer. An example of one such application is Microsoft Office applications which may be installed on the Microsoft Windows operating system all from Microsoft Inc. of Redmond, Wash. These may run on a personal computer (PC). These may be called local applications and a local operating system respectively as they are physically installed on the PC.

Recently an alternative has emerged where a user's files and applications may be hosted on servers in a data center and accessed across the Internet using a web browser. This arrangement may be called a web operating system, web desktop or a virtual hosted operating system as further defined in pending patent application PCT/IL2008/000318 entitled “VIRTUAL HOSTED OPERATING SYSTEM” published as WO2008/111049, the entire contents of which is incorporated herein by reference, and these terms are used interchangeably herein. In this context the term operating system does not include physical device drives but does typically include a hosted file system, desktop or other graphical user interface and other elements required to provide the user with a personal computing environment. An advantage is that the user's data is stored in a professional data center and may be accessed from any computer with a web browser, rather than being accessed from just one computer.

Additionally a virtual hosted operating system may be integrated with hosted applications such as the Google Docs word processor from Google Inc. of Mountainview, Calif. or the Zoho word processor from AdventNet, Inc. of Pleasanton, Calif., which themselves are hosted and accessed using a web browser. In this way the user may view their hosted files and edit them all within a web page in the web browser. The actual computer code for the application may run on the server or may be embedded in the downloaded web page to run in the browser on the PC or some combination of both as is known to those skilled in the art.

A problem emerges in that the applications currently available on the Web may be more limited or slower than applications available locally. For example, at the present time many users prefer to use Microsoft Office applications locally in preference to Web-based hosted applications such as Google Docs, since the Web-based hosted application may have fewer features or be less familiar.

However the security model of the web browser will typically prevent most types of communication between software running within a Web page—such as a Web Operating System—and local applications such as Microsoft Office, thus limiting the ability of the user to edit a common document in both local applications and hosted applications.

### SUMMARY OF THE INVENTION

It is an aim of the present invention to overcome at least some of the disadvantages of the prior art. In certain embodiments, the limitation preventing most types of communication between software running within the Web page and the local applications is overcome, and thus a hosted computing environment is allowed to interact seamlessly with local applications providing the user with a seamless way to interact with files hosted on the server via the browser, edit the files with local applications and save the edited files back to the server.

According to certain embodiments a user may use a web browser to see a web page in which they can see data files, such as documents or spreadsheets, which are stored remotely. The same web page might also contain a desktop and other aspects of a full user computing environment. Typically, it will be an interactive page including Javascript, Flash or another programming language to create a rich graphical user interface.

The user may indicate their desire to edit one of those files using a local application, such as Microsoft Word, which is installed on the same computer where the Web Browser is running The indication will be given by a user interface gesture within the web page. The local application is launched and the file selected by the user is preferably automatically opened by communicating with the server where that file is stored. The user is then able to edit their file using the local application and save the edited file on the remote server.

The above principle may be applied to several interactions between a Web Operating System and local applications, for example:
Editing file types such as documents, spreadsheets, presentations, images, video, sound, or databases which are hosted, using local applications;
Conversely, allowing files stored on the local computer to be listed, viewed and edited in the Web Page; and
Retrieving information from the local system such as, without limitation, a user's location (if the computer has a Global Positioning System), orientation (if the computer has an accelerometer), or battery level.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a high level block diagram of an exemplary embodiment of an arrangement comprising at least one data center and at least one personal computer;

FIGS. 2A-2C illustrate a plurality of screen shots of an embodiment of a user interface for launching a local editor program to edit a hosted file;

FIG. 3 illustrates a high level flow chart of a method for launching a local editor program to edit a hosted file.

### DETAILED DESCRIPTION OF THE PREFERRED EMBODIMENTS

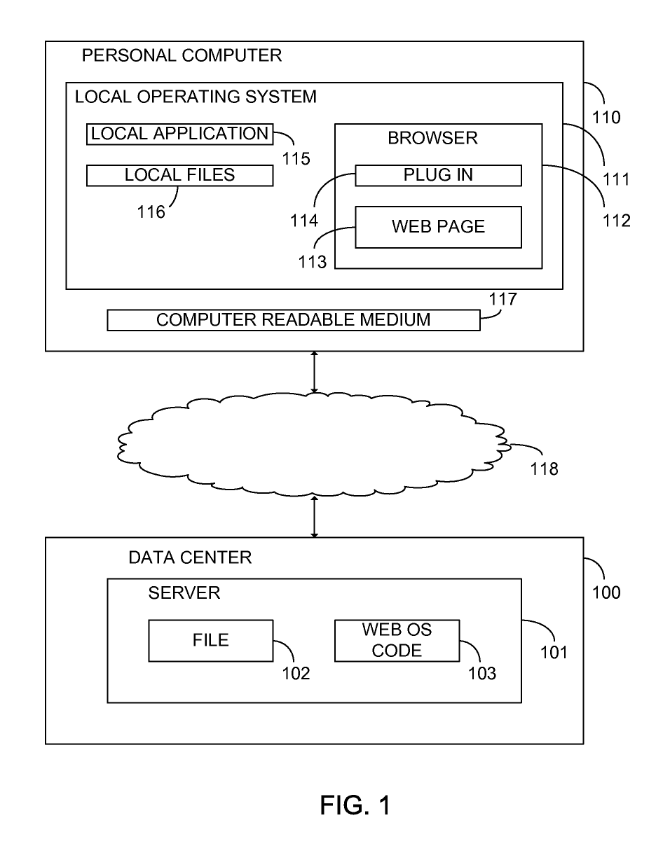

The overall design of the system may be understood with reference to FIG. 1, which illustrates a high level block diagram of an exemplary embodiment comprising: a data center or series of data centers 100 and a personal computer 110 interconnected via a network 118, such as the Internet. Data center 100 comprises a server or series of servers 101 each hosting at least one user data file 102 and a web operating system (OS) code 103 for embodying a virtual hosted operating system. Personal computer 110 comprises a local operating system (OS) 111 (such as Microsoft Windows, Mac OS or Linux) on which are installed one or more local applications(apps) 115 (such as Microsoft Word, OpenOffice, Adobe Photoshop), a locally stored user data file or files 116, and a web browser 112 (such as Internet Explorer which is included in Microsoft Windows or FireFox from the Mozilla foundation). Web browser 112 is operative to display a Web page 113 which includes within it part of web OS code 103 which has been transmitted from data server 101. Browser 112 preferably includes a plug-in 114 (such as the Java Runtime Environment from Sun Micrososystems Inc.). Instructions from operation of personal computer 110 are stored on a computer readable medium 117. Personal computer 110 further comprises a processor operative to load and run instructions stored on computer readable medium 117.

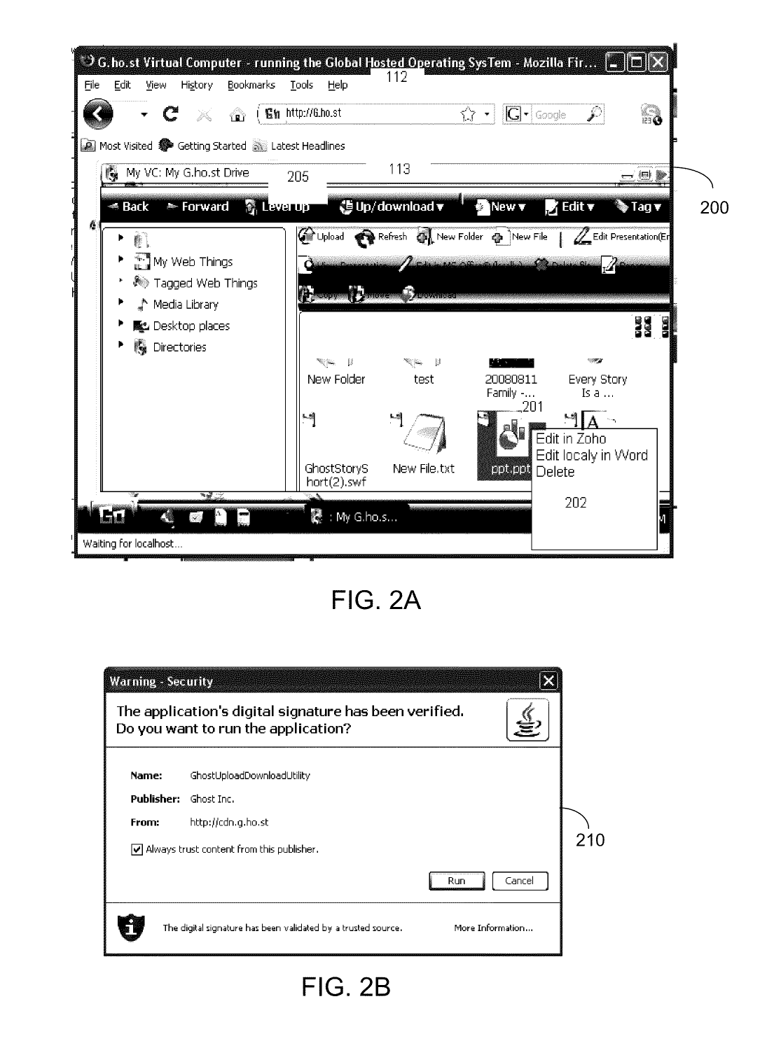

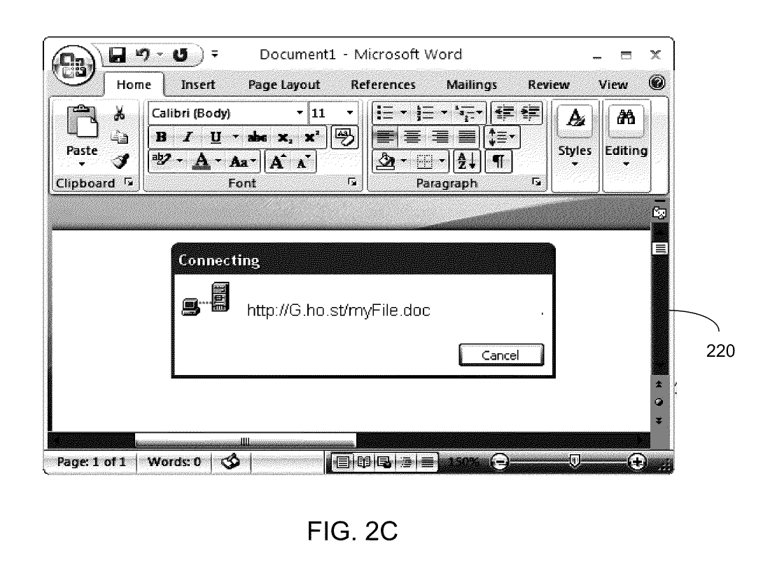

FIGS. 2A-2C illustrate a plurality of screen shots of an embodiment of a user interface. In FIG. 2A screen shot 200 displays web page 113 being displayed in web browser 112 of FIG. 1; a selected graphical representation 201 of a hosted user data file 102 of FIG. 1; and a graphical user interface 202.

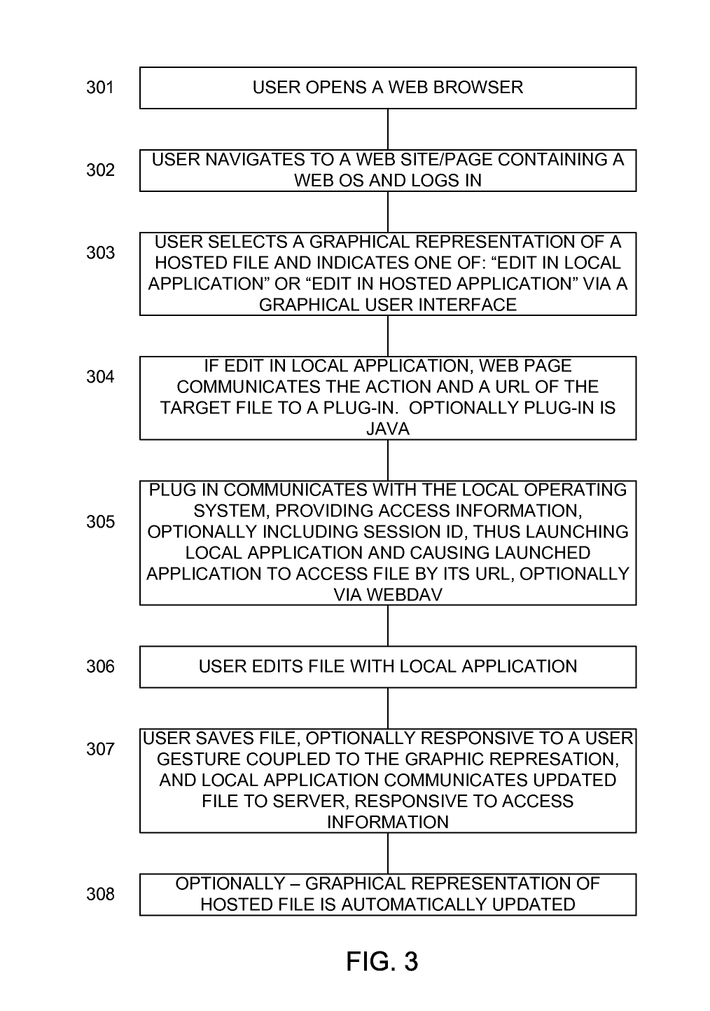

A typical use case and its embodiment may be understood by reference to the flow chart in FIG. 3, combined with the user interface examples in FIG. 2A and the high level block diagram of FIG. 1.

In the following example the user is using local operating system 111, described without limitation in reference to Microsoft Windows.

In stage 301 the user opens a web browser, such as web browser 112, illustrated without limitation as Mozilla Firefox.

In stage 302 the user types in to the web browser of stage 301 a URL, such as http://G.ho.st, causing the browser to load a web page, such as web page 113, including web OS code 103 from data server 101, which is rendered as web page 113. The user logs in to the web page and sees their desktop or some other representation of their hosted data, optionally together with settings, hosted apps, and other aspects of a personal computing environment.

In stage 303 the user selects graphical representation 201 of FIG. 2A within the web page of a hosted file 102 and indicates the desire to perform an action. Indication of desire to perform an action is optionally done by right-clicking graphical representation 201 with a mouse, thereby obtaining a context menu, such as graphical user interface 202, including an action such as “edit in local application” as illustrated in screenshot 200. The user then selects the desired action to be performed, in the present example, in which the local application is word, “edit locally in Word”. Preferably the user is also offered an alternative action of editing the file within the web page using a web word processor.

The embodiment of the above steps requires only common programming techniques well known to those versed in the art and further described in the pending patent application referenced above. In an exemplary embodiment, computer readable instructions implementing the above steps are stored in web OS code 103 and computer readable medium 117, respectively.

In stage 304, in the event that the user has selected to edit in local application, a portion of the computer readable instructions inside web page 113 communicates the user's request to plug-in 114. In a preferred embodiment plug-in 114 is included in browser 112, however this is not meant to be limiting in any way and an alternative plug-in 114 can be provided. In one preferred embodiment the plug-in is the Java Runtime Environment from Sun Microsystems. This plug-in has the advantage that it works with all popular browsers and is already installed in many browsers since it serves a large number of purposes. Alternative embodiments include using signed Javascript, using the Google Gears plug-in, or writing a plug-in “native” to the browser.

In the preferred embodiment wherein plug-in 114 is the Java Runtime Environment from Sun Microsystems, web page 113 will embed a signed Java applet, e.g. using the HTML <applet> tag and preferably including the MAYSCRIPT attribute in that tag. Alternatively the applet can be dynamically added to the web page responsively to the user making a request in stage 303, which requires the applet.

The following is an example of a Javascript function which can be used in all popular browsers to dynamically add a virtually invisible Java applet to a web page responsive to the need to execute stage 304:

function createAppletForLaunchingLocalApps ( ) {var
myApplet = document.createElement(“APPLET”);
myApplet.id = “ghostClientApplet”;
myApplet.archive = “../src/ghostClientApplet.jar”;
myApplet.code=
“ghost.clientApplet.ghostClientApplet.class”;
myApplet.width = “1”; // Some browsers can use 0 some
cannot
myApplet.height = “1”;
myApplet.MAYSCRIPT = “”;
var pageBody = document.getElementsByTagName(“body”)[0];
pageBody.appendChild(myApplet);
};

Preferably, at the time of initialization of the signed applet the user will automatically be asked to approve giving privileges to the signed applet with a user interface, as illustrated in screenshot 210 of FIG. 2B.

Once the applet is initialized the web page calls methods in the applet, for example to ask the applet to launch Microsoft Word and edit hosted file 102, which by way of example may be accessible using the URL http://g.ho.st/webdav/sampleDoc.doc. Thus, in one non-limiting illustrative embodiment the method call might be:
doLaunch(‘WINWORD’, ‘http://g.ho.st/webdav/sampleDoc.doc’)

In stage 305 plug-in 114 passes a command to local operating system 111 to launch local application 115 and to pass information to local application 115 on how to access hosted file 102.

The following is a typical embodiment of a method which will receive the name of a Windows application to launch and a parameter—typically identifying a file to edit—to pass to that application.

public void doLaunch(final String app, final String url){
// Make sure full privileges of applet apply even when
called from Javascript:
AccessController.doPrivileged(new PrivilegedAction( ) {
public Object run( ) {
try {Runtime.getRuntime( ).exec(new String[ ] {“cmd.exe”,
“/c”, “start”, app, url});
}
catch (IOException ioe) {
ioe.printStackTrace( );
}
return null;
}
});
}

The above method has been described in an embodiment in which local operating system 111 is Microsoft Windows, however this is not meant to be limiting in any way and an appropriate method can be provided for other local operating systems, including, without limitation, Linux.

In one optional embodiment, upon initialization the applet communicates back to the web page that it is initialized. In such an embodiment the web page will wait for this before calling the doLaunch( ) method described above.

Optionally the applet will access the local file system to check if the requested application, in the present example Microsoft Word, is installed and will warn the user if it is not.

The execution of this computer implemented method will cause Windows to launch the desired local application 115, in this example Microsoft Word, and will cause local application 115 to try to read hosted file 102 using the URL provided. In a preferred embodiment, the WEBDAV protocol is used to read and write remote files as this protocol is supported by Microsoft Office and other popular applications. In the current example Microsoft Word will issue an HTTP GET request to the URL provided and will read hosted file 102. While reading the file, in one particular embodiment the user will see a window such as the one shown in screen shot 220 of FIG. 2C.

Thus in a preferred embodiment two types of communication are used—the command to launch a local app 115 is communicated to local operating system 111 via the Java applet Runtime.getRuntime( ).exec method while the content of hosted file 102 is retrieved by the desired local app 115 using WEBDAV HTTP directly from the server. Alternatively, the content of the file is passed via the browser and the Java applet.

In a preferred embodiment, stage 305 includes passing some security information to enable the desired local application 115, such as Microsoft Word, to gain access to hosted file 102. For example the URL passed may itself include a secret temporary password (known as a session id) obtained from server 101 and passed, for example, as follows:

http://g.ho.st/webdav/sampleDoc.doc?secureSessionID=135791234

In stage 306 the user edits hosted file 102 by using the selected local application, such as local application 115.

In stage 307 the user presses the Save button in local application 115 and local application 115 sends the updated file to server 101, which will update hosted file 102. Optionally, instead of a save button, a second user gesture is provided by the user associated with graphical representation of the file. The updated file is preferably sent using a WEBDAV HTTP PUT message to the same URL, such as

PUT http://g.ho.st/webdav/sampleDoc.doc
?secureSessionID=135791234

This completes the two way communication between the virtual hosted operating system embodied by web OS code 103 and local OS 111.

In optional stage 308, web page 113 which embodies at least part of web OS code 103, is automatically updated to show the changes to hosted file 102. For example, the mouse over data on graphical representation 201 might be updated to show the new size and modified-date of updated hosted file 102.
In summary, the prior art includes the following user experiences:
A user views in the local OS an icon for a local file and gestures to launch a local editor which edits the file; and
the user views in a web page of a web OS an icon representing a hosted file and gestures to launch another web page (or frame) with a hosted editor which edits the file within the browser.

Advantageously, according to certain of the present embodiments, a “familiar” workflow achieves a completely new effect which is a novel mixture of the two known workflows: A user views in the web page of a virtual hosted operating system, embodied by a web OS code, an icon representing a hosted file and gestures to launch a local application which edits the file within a local OS.

The above is one example of the two way communication between a virtual hosted operating system embodied by a web OS code and a local operating system which according to certain of the present embodiments is used to enable a user workflow spanning the virtual hosted operating system and the local operating system.

Advantageously, the above method may be further implemented to allow files stored on personal computer 110 to be listed, viewed and edited in a web page. In particular, web OS code 103 is programmed to call local file 116 from the hosted application by passing a call with the target address of local file 116. Alternatively, other information may be retrieved by web OS code 103 from personal computer 110, such as: location of the personal computer 110, in the event that global positioning equipment is provisioned as part of personal computer 110; orientation of personal computer 110, in the event that personal computer 110 is supplied with one or more accelerometers; or battery level of personal computer 110, in the event the personal computer 110 is a portable battery operated device.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

We claim:

1. A hybrid operating system comprising:
a virtual hosted operating system comprising at least one file hosted on a server and a web page rendered in a browser, the web page including a graphical representation of said at least one hosted file;
a local operating system;
a local application running under said local operating system, said local application arranged to edit said at least one hosted file; and
a mechanism responsive to a user interface gesture within said web page to:
launch said local application; and
cause said local application to read said at least one hosted file.

2. The hybrid operating system of claim 1, wherein said mechanism passes access information to said local application, said local application arranged to read said at least one hosted file responsive to said access information.

3. The hybrid operating system of claim 2, wherein said access information comprises at least one universal record locator.

4. The hybrid operating system of claim 2, wherein said access information comprises at least one session identifier.

5. The hybrid operating system of claim 1, wherein said local application is further operative to save an edited version of said at least one hosted file to the server.

6. The hybrid operating system of claim 5, wherein said graphical representation of said at least one hosted file is automatically updated responsive to said saving of said edited version.

7. The hybrid operating system of claim 1, wherein said mechanism is at least partially implemented in a plug-in.

8. The hybrid operating system of claim 7, wherein said plug-in is the Java runtime environment.

9. The hybrid operating system of claim 1, wherein said local application reads said at least one hosted file via the WEBDAV protocol.

10. The hybrid operating system of claim 9, wherein said virtual hosted operating system passes a WEBDAV universal record locator and a session identifier to said local application said local application arranged to read said at least one hosted file responsive to said passed WEBDAV universal record locator and session identifier.

11. The hybrid operating system of claim 1, wherein said virtual hosted operating system is arranged to enable a user to choose between editing said at least one hosted file in the local application or editing said at least one hosted file in a hosted application by choosing alternative gestures coupled to the same graphical representation of said at least one hosted file.

12. A computer implemented method of personal computing comprising:
providing a virtual hosted operating system which includes at least one file hosted on a server and computer readable code running in a browser on a local computing equipment, said computer readable code running in a browser providing a graphical representation of the files;
providing a local operating system running on the local computing equipment; and
providing a local application arranged to run on said provided local computing equipment under said provided local operating system, the provided local application arranged to edit said at least one hosted file;
launching, responsive to a first user gesture coupled to a graphical representation of said at least one hosted file, said provided local application; and
causing said launched provided local application to read said at least one hosted file.

13. The method of claim 12, wherein said causing comprises:
passing access information to said provided local application, said launched provided local application reading said at least one hosted file responsive to said provided access information.

14. The method of claim 13, wherein said passed access information comprises at least one of a universal record locator and a session identifier.

15. The method of claim 12, further comprising:
saving, responsive to a second user gesture coupled to the graphical representation of said loaded at least one hosted file, an edited version of said at least one hosted file to said server.

16. The method of claim 15, further comprising:
automatically updating, responsive to said saving of said edited version, said graphical representation of said at least one hosted file.

17. A computer-readable medium containing instructions for controlling a computing device to perform a computer implemented method of personal computing, the method comprising:
providing a virtual hosted operating system which includes at least one file hosted on a server and code running in a browser on a local computing equipment, said code running in the browser providing a graphical representation of the at least one file;
providing a local operating system running on the local computing equipment; and
providing a local application arranged to run on said provided local computing equipment under said provided local operating system, the provided local application arranged to edit said at least one hosted file;
launching, responsive to a first user gesture coupled to a graphical representation of said at least one hosted file, said provided local application; and
causing said launched provided local application to read said at least one hosted file.

18. The computer-readable medium of claim 17, wherein said causing comprises:
passing access information to said provided local application, said launched provided local application reading said at least one hosted file responsive to said provided access information.

19. The computer-readable medium of claim 18, wherein said passed access information comprises at least one of a universal record locator and a session identifier.

20. The computer-readable medium of claim 17, wherein said method further comprises:
saving, responsive to a second user gesture coupled to the graphical representation of said loaded at least one hosted file, an edited version of said at least one hosted file to said server.
